(19) United States
(12) Patent Application Publication
(10) Pub. No.: US 2015/0242609 A1
(43) Pub. Date: Aug. 27, 2015

(54) Universal Authenticator Across Web and Mobile

(71) Applicant: Google Inc., Mountain View, CA (US)

(72) Inventors: Wentao Zheng, Jersey City, NJ (US); Zutao Zhu, Jersey City, NJ (US)

(73) Assignee: Google Inc., Mountain View, CA (US)

(21) Appl. No.: 14/188,682

(22) Filed: Feb. 24, 2014

(51) Int. Cl. G06F 21/34; G06F 21/35

(52) U.S. Cl. CPC G06F 21/34; G06F 21/35

(57) ABSTRACT

Applications that rely on user authentication information execute within an application container on the computing device. The application container comprises a plug receiver module and a delegate module. When a request for authentication is initiated, the user is prompted to connect a remote identification device to the computing device. The remote identification device stores an encrypted version of a user secret code. The plug receiver module reads the encrypted version of the user secret code and communicates the encrypted information to a remote authentication server. The remote authentication server decrypts the user secret code and uses the decrypted user secret code to identify and communicate corresponding user authentication information to the delegate module. The delegate module establishes an authenticated session by making the user authentication information available to the applications executing in the application container.

### TECHNICAL FIELD

The present disclosure relates generally to authenticating users to computing devices and applications executing on the computing devices and, more particularly, to authenticating users to computing devices and applications executing on the computing devices without requiring the user to enter a password.

### BACKGROUND

User authentication is a daily exercise for users when logging on to work and personal computers and accessing various web sites on the Internet. This authentication results in the user needing to use and remember a number of different login credentials. Further, with increasing security requirements imposed by various service providers that require the use of a mixture of digits, uppercase and lowercase characters, and special characters, passwords have become more difficult to remember. If a password is stolen, it is often not possible to determine that the password has been compromised until well after the fact. Accordingly, there is a need in the art for offline and online user authentication measures that are secure but that do not require the laborious process of maintaining and entering multiple passwords.

### SUMMARY

In certain example embodiments described herein, a method for authenticating users on computing devices without passwords comprises receiving a request for user authentication on a computing device, detecting connection of a remote identification device to the computing device, reading an encrypted user secret code from the remote identification device, communicating the encrypted user secret code to a remote authentication server, receiving user authentication information from the remote authentication server, and establishing an authenticated session by providing the user authentication information to one or more requesting applications on the computing device.

In certain other example embodiments described herein, a system and a computer program product for authenticating users on computing devices without a password are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for authenticating users to computing devices without a password, in accordance with certain example embodiments.

FIG. 2 is a block flow diagram depicting a method to authenticate users to computing devices without a password, in accordance with certain example embodiments.

FIG. 3 is a block flow diagram depicting a method for registering users to a remote identification device, in accordance with certain example embodiments.

FIG. 4 is a block diagram depicting a computing machine and a module, in accordance with certain example embodiments.

### DETAILED DESCRIPTION OF THE EXAMPLE EMBODIMENTS

### Overview

The embodiments described herein provide a system and method for authenticating users on computing devices without requiring a user password. Applications that require authentication execute within an application container on a computing device. The application container may be a computing device operating system, or a browser application. In the context of a browser application operating environment, the other applications are web pages or web views displayed in the browser application. Upon receiving a request from one or more applications for user authentication information, a plug receiver module executing in the application container determines if a communication channel with a remote identification device has been established. The communication channel may be a wired or wireless communication channel. The remote identification device stores an encrypted user secret code. If a remote identification device is detected, the plug receiver module reads the encrypted user secret code from the remote identification device.

The plug receiver module then communicates the encrypted version of the user secret code to a delegate module executing within the application container. The delegate module communicates the encrypted user secret code to a remote authentication server. A copy of the encrypted user secret code is not stored or maintained on the computing device. Other applications executing on the computing device do not have access to the encrypted user secret code. The remote authentication server decrypts the encrypted user secret code and uses the decrypted user secret code to identify corresponding user authentication information stored on the remote authentication server. The user authentication information may be, for example, a username or an account number. The remote authentication server communicates the user authentication information to the delegate module on the computing device.

The delegate module then establishes an authenticated session for the one or more requesting applications. The plug receiver module monitors the connection with the remote identification device and terminates the authenticated session when the remote identification device is removed or the communication channel with the remote identification device is otherwise closed.

Turning now to the drawings, in which like numerals represent like (but not necessarily identical) elements throughout the figures, example embodiments are described in detail.

### Example System Architectures

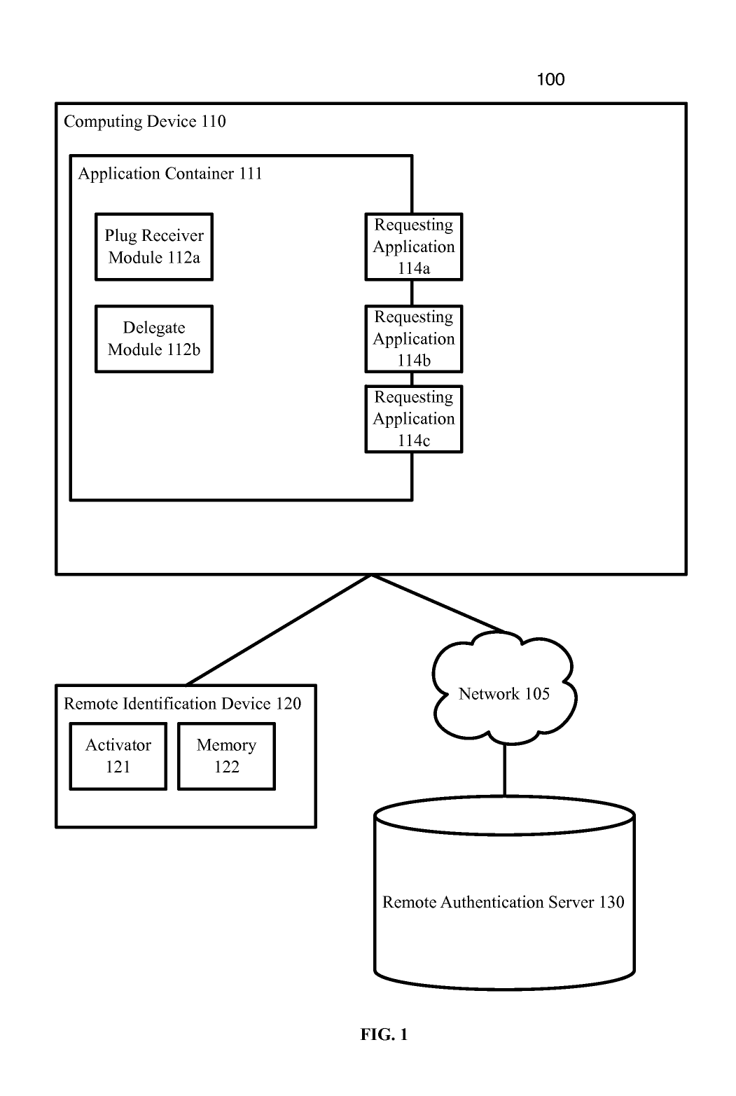

FIG. 1 is a block diagram depicting a system 100 for authenticating users to computing devices and applications without requiring entry of a user password, in accordance with certain example embodiments. As depicted in FIG. 1, the system 100 includes network computing devices 110, 120, and 130 that are configured to communicate with one another via one or more networks 105. In some embodiments, a user associated with a device must install an application and/or make a feature selection to obtain the benefits of the techniques described herein. Additionally, the network computing devices 110 and 120 may communicate via a direct connection.

Each network 105 includes a wired or wireless telecommunication means by which network devices (including devices 110, 120 and 130) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device 110 and 130 includes a device having a communication module capable of transmitting and receiving data over the network 105. For example, each network device 110, 120, and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 120 are operated by end-users or consumers (not depicted) and the network device 130 is operated by authentication server operators (not depicted).

It will be appreciated that the network connections shown are example and other means of establishing a communications link between the computers and devices can be used. Moreover, those having ordinary skill in the art having the benefit of the present disclosure will appreciate that the computing device 110, remote identification device 120, and the remote authentication server 130 illustrated in FIG. 1 can have any of several other suitable computer system configurations. For example a computing device 110 embodied as a mobile phone or handheld computer may not include all the components described above. Additionally, the computing device 120 embodied as a remote identification dongle may not include all the components described above.

### Example Processes

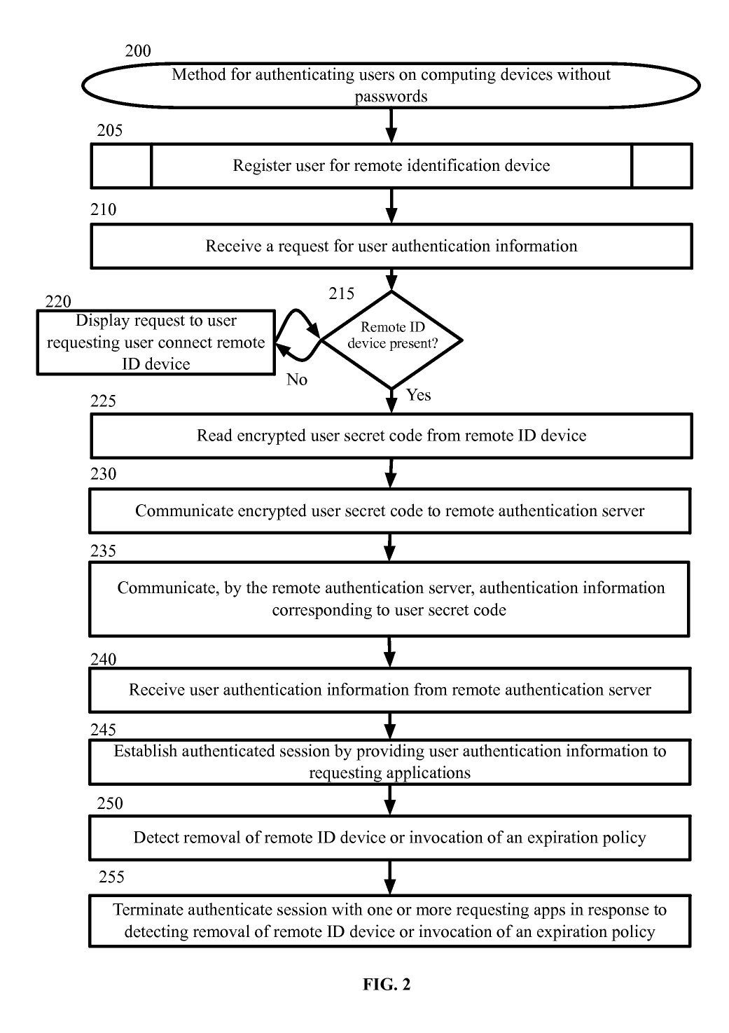

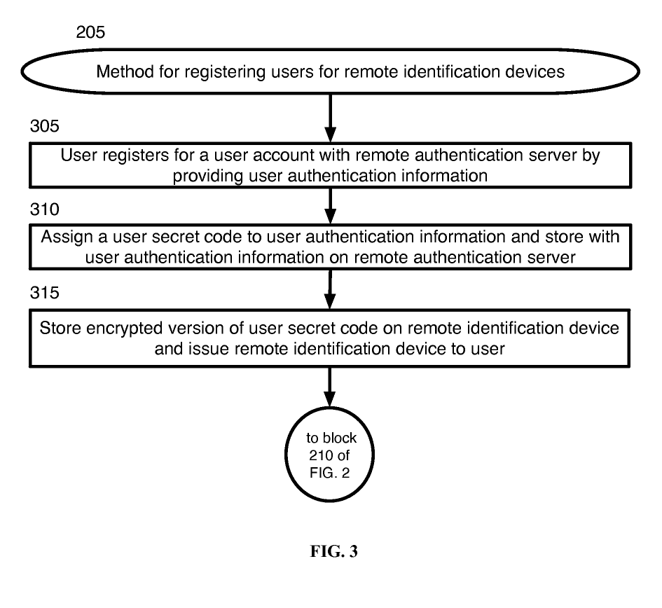

The example methods illustrated in FIGS. 2 and 3 are described hereinafter with respect to the components of the example operating environment 100. The example methods of FIGS. 2 and 3 may also be performed with other systems and in other environments.

FIG. 2 is a block flow diagram depicting a method 200 to authenticate users on computing devices without passwords, in accordance with certain example embodiments.

Method 200 begins at block 205, where a user registers for a remote identification device 120. Method 205 will be described in further detail with reference to FIG. 3.

FIG. 3 is a block flow diagram depicting a method 205 for registering users for remote identification devices. Method 205 begins at block 305 where a user registers with the authentication system. For example, the user may log on to a web site hosted by the remote authentication server 130. During registration the user provides user authentication information to the remote authentication information. The user authentication information may include user names, account numbers, or any other user-specific identifying information required by online services or software applications executing on one or more of the user computing devices.

At block 310, the remote authentication server 130 stores the received user authentication information in a user record and assigns the record a corresponding user secret code.

At block 315, the user secret code is encrypted using an encryption technology, such as symmetric or asymmetric encryption or a hash generation algorithm. The encrypted version is then stored on a remote identification device 120 and issued to the user. The remote identification device 120 comprises a memory 122 that stores the user secret code in encrypted format only. The remote identification device 120 may be a small device, for example a flash drive sized device or smaller, that connects to the computing device 110 via a wired connection, such as through a USB port, or via a wireless connection, such as Bluetooth, NFC, RFID, Wi-Fi or other suitable connection. Alternatively, the remote identification device 120 may be a wireless card device that connects to the computing device 110 using a wireless connection. Wireless remote identification devices 120 may further comprise an activator module 121. The activator 121 detects the user's intent to connect the remote identification device 120 to the computing device 110 and may detect touch, motion, or voice commands or interrogation of the device 120 by the computing device 110. In certain example embodiments, the remote identification device 120 can be sized to include the above components and to be portable, non-obtrusive, and easily accessible by the user. In the event a remote identification device 120 is lost or stolen, the remote identification device 120 can be frozen by freezing the corresponding user account on the remote authentication server 130.

Returning to block 210 of FIG. 2, a plug receiver module 112a executing on the computing device 110 receives a request for user authentication information. The request for authentication information may be received when the computing device 110 boots up or wakes from a sleep or power saving mode. Alternatively, the request for authentication information may be received from one or more requesting applications 114a-c after boot up. For example, the requesting application may be a banking application that requires user authentication information to authorize a payment. The plug receiver module 112a and all requesting applications 114 execute in an application container 111. When a requesting application 114 determines it needs user authentication information, the requesting application 114 communicates the authentication request to the application container 111 and the request is received by the plug receiver module 112a. The application container 111 may be a computing device operating system or a browser application. In the context of an operating system, the applications are individual software applications executing on the computing device 110, such as an electronic wallet application or banking application. In the context of a browser application, the applications are individual web pages or web views, such as a user login web page. In certain example embodiments, the plug receiver module 112a may communicate a message for display on the computing device 110 indicating a request for user authentication information has been received. The message may further request that the user connect the user's remote identification device 120 to the computing device 110.

If the user wants to provide the requested authentication, the user will then connect the user's remote identification device 120 to the computing device 110 by either plugging the remote identification device 120 directly into the proper port on the computing device 120, or by engaging the activator 121 to establish a wireless connection with the computing device 120. The method then proceeds to block 215.

At block 215, the plug receiver module 112a determines if the remote identification device 120 is connected to the computing device 110. The plug receiver module 112a allows a remote identification device 120 to connect to and communicate with the computing device 110. The plug receiver module 112a may allow the remote identification device 120 to connect with the computing device 110 using a wired or wireless connection. The plug receiver module 112a may wait for a set period of time to determine if a remote identification device 120 is connected. If the set time period elapses and a remote identification application 120 has not been detected, the method proceeds to block 220.

At block 220, the plug receiver module 112a communicates a message for display by the computing device 110. The message indicates a remote connection device 120 has not been detected and requests the user connect the user's remote identification device 120. The plug receiver module 112a may then wait again for the set period of time to determine if a remote identification device 120 is connected. This process may repeat for a defined number of iterations before the process and method 200 terminates. If the plug receiver module 112a detects a remote identification device 120, the method then proceeds to block 225.

At block 225, the plug receiver module 112a reads or otherwise receives the encrypted user secret code stored on the remote identification device 120. The plug receiver module 112a communicates the encrypted user secret code to the delegate module 112b. The plug receiver module 112a does not store the encrypted user secret code on the computing device 110 and does not provide access to the encrypted user secret code to the requesting applications 114 or other components of the computing device 110. In certain example embodiments, the plug receiver module 112a only communicates the encrypted secret code to the delegate module 112b after reading the encrypted secret code from the remote identification device 120, and does not store or maintain a copy of the encrypted user secret code in a permanent or temporary data storage structure on the computing device 110.

At block 230, the delegate module 112b communicates the encrypted user secret code to a remote authentication server 130. In certain example embodiments, the delegate module 112b may request a secondary authorization from the user after receiving the encrypted user secret code from the plug receiver module 112a and before communicating the encrypted user secret code to the remote authentication server 130. For example, the delegate module 112b may communicate a user interface object to be displayed by the computing device 110, the user interface object prompting the user to input a password or personal identification number or other suitable authentication information. This secondary authentication information may be stored by the delegate module 112b or may be read by the plug receiver module 112a from the remote identification device 120 and communicated to the delegate module 112b with the encrypted user secret code.

In certain example embodiments, the delegate module 112b may further communicate a user interface object to be displayed on the computing device 110 that asks the user if they would like to set or otherwise configure an expiration policy. The expiration policy may define a time period or other event that triggers termination of the authenticated session obtained by the delegate module 112b. The user interface object may also prompt the user to set the scope of the authentication. For example, the user may limit the number or types of applications that may rely on the authentication information for the duration of the current authentication session.

In certain example embodiments, the delegate module 112b only communicates the encrypted secret code to the remote authentication server after receiving the encrypted secret code from the plug receiver module 112a, and does not store or maintain a copy of the encrypted user secret code in a permanent or temporary data storage structure on the computing device. In certain other example embodiments, the delegate module 112b deletes any copy of the encrypted user secret code that has been temporarily stored in any data structure on the computing device 110 after communicating the encrypted user secret code to the remote authentication server 130.

At block 235, the remote authentication server 130 decrypts the encrypted user secret code. The type of decryption used will depend on the encryption used to and create and store the user secret code on the remote identification device 120. For example, if the user secret code is encrypted using symmetric or asymmetric cryptography, the remote authentication server 130 will store the corresponding encryption key needed to decrypt the user secret code. Likewise, if the user secret code is stored on the remote identification device 120 as a secure hash, the remote identification server 130 will maintain a copy of the corresponding hash key and hash algorithm needed to regenerate the user secret code. The remote authentication server 130 contains user records comprising user authentication information and the assigned user secret code. The remote authentication server 130 uses the decrypted user secret code to identify the user record with the corresponding assigned user secret code then may then read the user authentication information corresponding to the identified record. The user authentication information may be a user name, account number, password, or other user-specific identifying information. After identifying the corresponding authentication information, the remote authentication server 130 communicates the authentication information to the delegate module 112b. In certain example embodiments, the remote authentication server 130 encrypts the authentication information prior to communicating the authentication information to the authentication module 112a. This encryption used to encrypt the user authentication information may be different than the encryption used to encrypt the user secret code and is used for secure transmission from the remote authentication server 130 to the computing device 110.

At block 240, the delegate module 112b receives the user authentication information from the remote authentication server 130. If the user authentication information is encrypted, the authentication module 112b decrypts the authentication information. The authentication module 112a may store the authentication information in encrypted or decrypted form in a temporary data space, such as a pasteboard.

At block 245, the delegate module 112a establishes an authenticated session by providing access to the authentication information to the one or more requesting applications. In one example embodiment, the authentication information may be communicated directly to the one or more requesting applications 114. In another example embodiment, the authentication module 112a may provide a URL where the authentication information can be temporarily accessed by the one or more requesting applications. The requesting application does not have access to the user secret code at any point during the execution of method 200.

At block 250, the connection module 112b detects that the remote identification device 120 has been disconnected, or that an expiration policy has been invoked. For example, a set time limit may have expired.

At block 255, the authentication module 112a terminates the authenticated session with the one or more requesting applications 114 in response to detecting the remote identification device 120 has been disconnected or an expiration policy invoked. For example, the delegate module 112a may erase the authentication information previously made available to the authentication applications. In certain example embodiments, the delegate module 112a may execute a logout protocol that logs out the user or requires the requesting applications or browser application to shut down.

### Other Example Embodiments

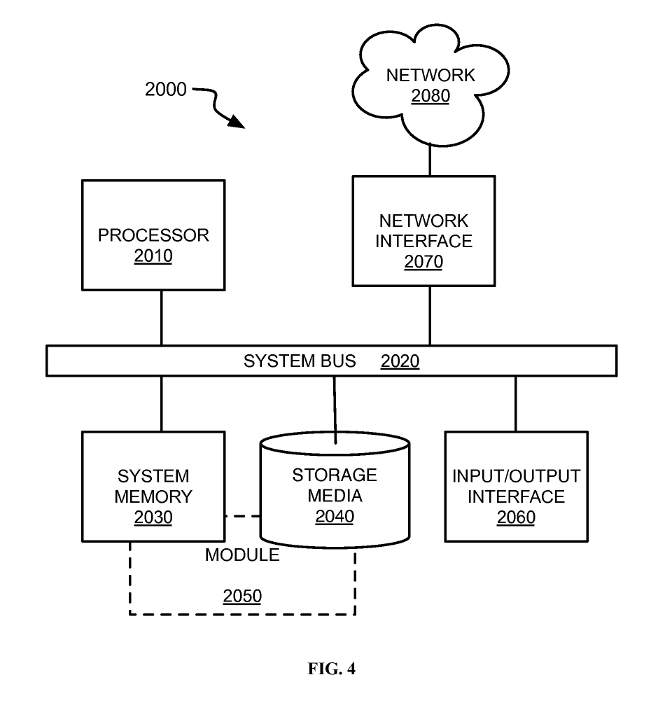

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the following claims, the scope of which is to be accorded the broadest interpretation so as to encompass such alternative embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to authenticate users on computing devices without passwords, comprising:
receiving, by a plug receiver module executing in an application container on a computing device, a request for user authentication information from a requesting application, wherein the application container is an operating system or a browser application;
detecting, by the plug receiver module, a connection of a remote identification device to the computing device, the remote identification device having stored therein an encrypted version of a user secret code;
reading, by the plug receiver module, the encrypted version of the user secret code from the remote identification device;
communicating, by the plug receiver module, the encrypted version of the user secret code to a delegate module executing in the application container;
communicating, by the delegate module, the encrypted user secret code to a remote authentication server, wherein the remote authentication server decrypts the encrypted user secret code and uses the decrypted user secret code to identify and communicate corresponding user authentication information to the delegate module;
receiving, by the delegate module, the user authentication information from the remote authentication server; and
establishing, by the delegate module, an authenticated session by communicating the user authentication information to the requesting application.

2. The method of claim 1, wherein the remote identification device connects to the computing device using a wired communication channel.

3. The method of claim 1, wherein the remote identification device connects to the computing device using a wireless communication channel.

4. The method of claim 1, wherein the application container is an operating system.

5. The method of claim 1, wherein the application container is a browser application, and the one or more applications are individual web pages or web views.

6. The method of claim 1, wherein the computing device is a mobile phone computing device

7. The method of claim 1, wherein the authentication credentials comprise a user identifier.

8. The method of claim 1, wherein the authentication credentials comprise an account number.

9. The method of claim 1, further comprising:
monitoring, by the plug receiver module, the connection between the remote identification device and the computing device;
detecting, by the plug receiver module, that the communication channel between the remote identification device and the computing device is closed; and
in response to detecting that the communication channel is closed by the plug receiver module;
terminating, by the delegate module, user access to the one or more requesting applications.

10. A computer program product, comprising:
a non-transitory computer-executable storage device having computer-readable program instructions embodied thereon that when executed by a computer cause the computer to authenticate users to the computer without a password, the computer-executable program instructions comprising:
computer-executable program instructions to receive a request for user authentication information from one or more requesting applications executing in an application container on a computing device;
computer-executable program instructions to detect a connection of a remote identification device to the computer;
computer-executable program instructions to read an encrypted user secret code stored on the remote identification device;
computer-executable program instructions to communicate the encrypted user secret code to a remote authentication server, wherein the remote authentication server decrypts the encrypted user secret code and uses the user secret code to identify and communicate corresponding user authentication information to the authentication application;
computer-executable program instructions to receive the user authentication information from the remote authentication server; and
computer-executable program instructions to communicate the user authentication information to the one or more requesting applications.

11. The product of claim 10, wherein the remote identification device connects to the computer using a wired communication channel.

12. The product of claim 10, wherein the remote identification device connects to the computer using a wireless communication channel.

13. The product of claim 10, wherein the application container is an operating system.

14. The product of claim 10, wherein the application container is a browser application, and the one or more applications are individual web pages.

15. The product of claim 10, wherein the authentication credentials comprise a user identifier or an account identifier.

16. A system to authenticate users on computing devices without a password, comprising:
a remote authentication server comprising user records and one or more decryption keys, the user records comprising user authentication information and a user secret code;
a remote identification device comprising a memory that stores an encrypted version of the user secret code;
a computing device comprising a storage device and a processor communicatively coupled to the storage device, wherein the processor executes application code instructions that are stored in the storage device and that cause the computing device to:
receive a request for user authentication information from a requesting application executing in an application container on the computing device;
detect a connection of the remote identification device to the computing device;
read the encrypted version of the user secret code stored on the remote identification device;
communicate the encrypted user secret code to the remote authentication server, wherein the remote authentication server decrypts the encrypted user secret code using the one or more decryption keys and uses the decrypted user secret code to identify and communicate corresponding user authentication information to the computing device;
receive the user authentication information from the remote authentication server; and
communicate the user authentication information to the requesting application executing on the computing device.

17. The system of claim 16, wherein the remote identification device connects to the computing device using a wired communication channel.

18. The system of claim 16, wherein the remote identification device connects to the computing device using a wireless communication channel.

19. The system of claim 16, wherein the application container is a computing device operating system.

20. The system of claim 16, wherein the application container is a browser application, and the one or more requesting applications are individual web pages.
